(19) United States
(12) Patent Application Publication
(10) Pub. No.: US 2026/0124576 A1
(43) Pub. Date: May 7, 2026

(54) HYDROGEN PURIFICATION SYSTEM AND HYDROGEN PURIFICATION METHOD

(71) Applicant: Industrial Technology Research Institute, Hsinchu (TW)

(72) Inventors: Shuan Lin, Hsinchu City (TW); Sung-Chun Chang, Hsinchu City (TW); Chien-Ming Lai, Hsinchu County (TW); Li-Duan Tsai, Hsinchu City (TW)

(73) Assignee: Industrial Technology Research Institute, Hsinchu (TW)

(21) Appl. No.: 19/000,719

(22) Filed: Dec. 24, 2024

(30) Foreign Application Priority Data
Nov. 6, 2024 (TW) 113142506

(51) Int. Cl. B01D 53/32

(52) U.S. Cl. CPC B01D 53/326; B01D 2256/16; B01D 2257/102

(57) ABSTRACT

A hydrogen purification system and a hydrogen purification method are provided. The hydrogen purification system includes a purification device, a water supply device and a hydrogen-containing gas supply device. The purification device includes an anode, a cathode and an electrolyte membrane located between the anode and the cathode. The water supply device is connected to the cathode and provides liquid water to the cathode. The hydrogen-containing gas supply device is connected to the anode to supply hydrogen-containing gas to the anode. During a hydrogen purification process, the liquid water is continuously supplied to the cathode in an uninterrupted manner.

### CROSS-REFERENCE TO RELATED APPLICATION

This application claims the priority benefit of Taiwan application serial no. 113142506, filed on November 6, 2024. The entirety of the above-mentioned patent application is hereby incorporated by reference herein and made a part of specification.

### BACKGROUND

### TECHNICAL FIELD

The technical field relates to a hydrogen purification technology, and particularly relates to a hydrogen purification system and a hydrogen purification method.

### BACKGROUND

With the development of technology, net-zero carbon emission has become one of the goals to be achieved in development. For this reason, hydrogen energy is considered as one of the important alternative energy sources. In the semiconductor industry, as advanced manufacturing processes expand, the demand for high-purity hydrogen has increased significantly. In view of this, how to effectively provide hydrogen with high throughput, high recovery rate, and high purity, as well as its recovery and purification technology, has become a current research topic.

### SUMMARY

One of exemplary embodiments comprises a hydrogen purification system including a purification device, a water supply device, and a hydrogen-containing gas supply device. The purification device includes an anode, a cathode, and an electrolyte membrane located between the anode and the cathode. The water supply device is connected to the cathode and provides liquid water to the cathode. The hydrogen-containing gas supply device is connected to the anode to supply hydrogen-containing gas to the anode. During a hydrogen purification process, the liquid water is continuously supplied to the cathode in an uninterrupted manner.

One of exemplary embodiments comprises a hydrogen purification method including: using the aforementioned hydrogen purification system; initiating the water supply device to supply liquid water to the cathode; introducing hydrogen-containing gas; and performing the hydrogen purification reaction. During a hydrogen purification process, the liquid water is continuously supplied to the cathode in an uninterrupted manner.

To make the features and advantages of the disclosure clearer and easier to understand, the following gives a detailed description of embodiments with reference to accompanying drawings.

### BRIEF DESCRIPTION OF THE DRAWINGS

FIG. 1 is a schematic diagram of a hydrogen purification system according to an exemplary embodiment.

FIG. 2 is a schematic flow chart of a hydrogen purification method according to an exemplary embodiment.

FIG. 3 shows the change in current density measured over time during hydrogen purification using the hydrogen purification system according to Example 1 of the disclosure.

FIG. 4 shows the change in current density measured over time during hydrogen purification using the hydrogen purification system according to Comparative Example 1 of the disclosure.

FIG. 5 shows the change in current density measured over time during hydrogen purification using the hydrogen purification system according to Comparative Example 2 of the disclosure.

### DESCRIPTION OF THE EMBODIMENTS

The following will comprehensively describe exemplary implementations of the disclosure with reference to the figures, but the disclosure may also be implemented in many different forms and should not be construed as limited to the implementations described herein. In the figures, the sizes and thicknesses of components, parts, and layers may not be drawn to actual scale for clarity. Directional terms mentioned in this document, such as "upper", "lower", "front", "back", etc., are only referenced to the orientation of the accompanying figures. Therefore, the directional terms used are for explaining and understanding this application, and not for limiting this application. Additionally, in the specification, unless explicitly described otherwise, the word "include" will be understood to mean including the stated elements, but not excluding any other elements. For ease of understanding, the same elements in the following description will be explained using the same symbols.

The implementation details provided in the implementations are for illustrative purposes and are not intended to limit the scope of protection of the disclosure. Any expert in the relevant technical field may modify or vary these implementation details according to the needs of actual implementation. Moreover, descriptions of well-known devices, methods, and materials may be omitted to avoid obscuring the description of the various principles of the disclosure.

Ranges in this document may be expressed from "about" one specific value to "about" another specific value, or may be directly expressed as one specific value and/or to another specific value. When expressing said range, another implementation includes from that one specific value and/or to another specific value. Similarly, when values are expressed as approximations by using the antecedent "about", it will be understood that the specific value forms another implementation. It will be further understood that the endpoints of each range are apparently related or unrelated to another endpoint.

In this document, non-limiting terms (such as: may, can, for example, or other similar expressions) are for non-essential or optional implementation, inclusion, addition, or presence.

In this document, "connect" may refer to direct connection or indirect connection. In the case of direct connection, there may be physical contact between two components and a direct connection therebetween, and no intermediate components exist between the two components; while in the case of indirect connection, there are other suitable components between the two components, allowing the two components to be connected to each other through intermediate components between them, and there is no physical contact between the two components.

Unless otherwise defined, all terms used herein (including technical and scientific terms) have the same meanings as commonly understood by experts in the technical field to which the disclosure pertains. It will also be understood that terms, such as those defined in commonly used dictionaries, should be interpreted as having meanings consistent with their meaning in the context of the relevant art and should not be interpreted in an idealized or overly formal sense unless explicitly so defined herein.

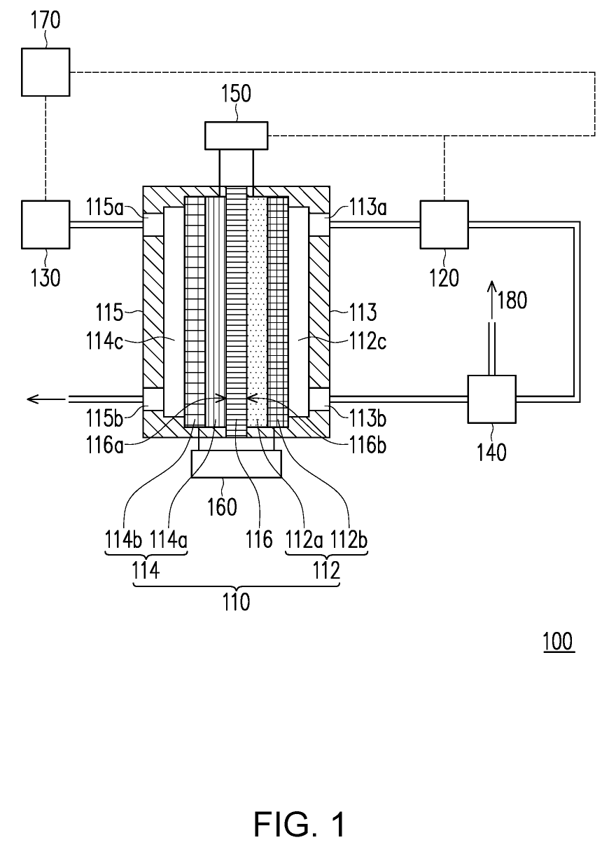

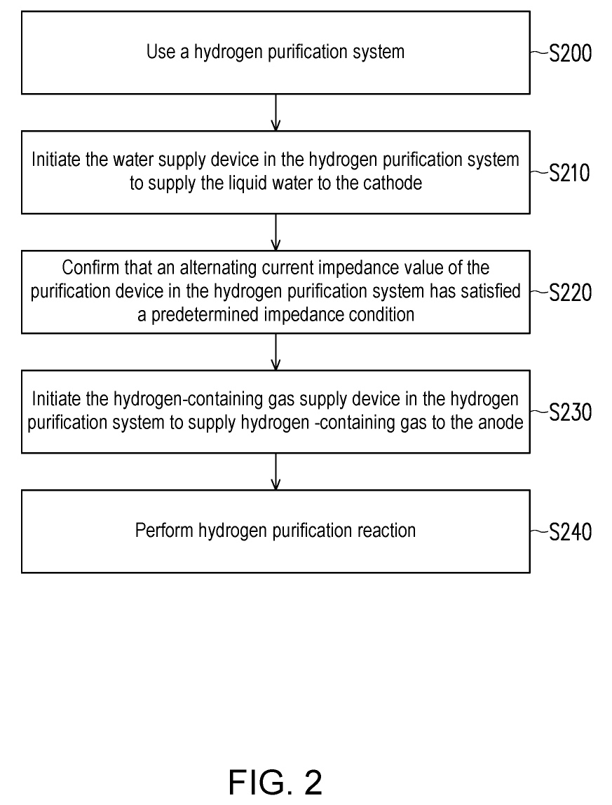

FIG. 1 is a schematic diagram of a hydrogen purification system according to an exemplary embodiment. FIG. 2 is a schematic flow chart of a hydrogen purification method according to an exemplary embodiment.

Please refer to both FIG. 1 and FIG. 2, in step S200, a hydrogen purification system 100 is used. The hydrogen purification system 100 includes a purification device 110, a water supply device 120, and a hydrogen-containing gas supply device 130. In this embodiment, the hydrogen purification system 100 may further include a gas-liquid separation device 140, a power supply 150, an alternating current impedance analysis device 160, a controller 170, or other components well known to people having ordinary skills in the art, which will not be described in detail herein.

The purification device 110 includes a cathode 112, an anode 114, and an electrolyte membrane 116.

The cathode 112 may include a cathode catalyst layer 112a and a cathode gas diffusion layer 112b. The cathode catalyst layer 112a may contact the electrolyte membrane 116, for example, the cathode catalyst layer 112a may contact a main surface 116a of the electrolyte membrane 116. The cathode gas diffusion layer 112b may contact a cathode separator 113. There may be a cathode flow channel 112c between the cathode separator 113 and the cathode 112 to allow liquid water provided by the water supply device 120 to pass through. For example, the cathode separator 113 may have a cathode inlet 113a and a cathode outlet 113b to allow the liquid water provided by the water supply device 120 to permeate from the outer surface to the inner surface of the cathode separator 113. The liquid water provided by the water supply device 120 may flow into the inner surface of the cathode separator 113 via the cathode inlet 113a of the cathode separator 113, pass through the cathode flow channel 112c, and flow out as treated liquid water and purified hydrogen from the cathode outlet 113b of the cathode separator 113.

A material of the cathode 112 may include metal, carbon, plastic, or other suitable materials. A material of the cathode catalyst layer 112a may include platinum, platinum alloy, nickel, or other suitable materials. A material of the cathode gas diffusion layer 112b may include porous metal, carbon paper, carbon cloth, or other suitable materials. A material of the cathode separator 113 may include metal, graphite, conductive plastic, or other suitable materials. A shape of the cathode flow channel 112c is not particularly limited and may be selected according to needs. For example, the cathode flow channel 112c may be a groove-shaped flow channel formed on the cathode separator 113.

The anode 114 may include an anode catalyst layer 114a and an anode gas diffusion layer 114b. The anode catalyst layer 114a may contact the electrolyte membrane 116, for example, the anode catalyst layer 114a may contact another main surface 116b of the electrolyte membrane 116. The anode gas diffusion layer 114b may contact an anode separator 115. There may be an anode flow channel 114c between the anode separator 115 and the anode 114 to allow hydrogen-containing gas provided by the hydrogen-containing gas supply device 130 to pass through. For example, the anode separator 115 may have an anode inlet 115a and an anode outlet 115b to allow the hydrogen-containing gas provided by the hydrogen-containing gas supply device 130 to permeate from the outer surface to the inner surface of the anode separator 115. The hydrogen-containing gas provided by the hydrogen-containing gas supply device 130 may flow into the inner surface of the anode separator 115 via the anode inlet 115a of the anode separator 115, pass through the anode flow channel 114c, and flow out as hydrogen-containing gas that has not passed through the cathode 112 from the anode outlet 115b of the anode separator 115.

A material of the anode 114 may include metal, carbon, plastic, or other suitable materials. A material of the anode catalyst layer 114a may include platinum, platinum alloy, nickel, or other suitable materials. A material of the anode gas diffusion layer 114b may include porous metal, carbon paper, carbon cloth, or other suitable materials. A material of the anode separator 115 may include metal, graphite, conductive plastic, or other suitable materials. The material of the anode 114 may be the same as or different from the material of the cathode 112. The material of the anode catalyst layer 114a may be the same as or different from the material of the cathode catalyst layer 112a. The material of the anode gas diffusion layer 114b may be the same as or different from the material of the cathode gas diffusion layer 112b. The material of the anode separator 115 may be the same as or different from the material of the cathode separator 113.

A shape of the anode flow channel 114c is not particularly limited and may be selected according to needs. For example, the anode flow channel 114c may be a groove-shaped flow channel formed on the anode separator 115. The shape of the anode flow channel 114c may be the same as or different from the shape of the cathode flow channel 112c.

The electrolyte membrane 116 is located between the cathode 112 and the anode 114. The electrolyte membrane 116 may include main surfaces 116a and 116b opposite to each other. The main surfaces 116a and 116b may contact the cathode 112 and the anode 114, respectively. In this embodiment, the main surface 116a may directly contact the cathode catalyst layer 112a. The main surface 116b may directly contact the anode catalyst layer 114a. A material of the electrolyte membrane 116 may include fluorocarbon-based polymer, hydrocarbon-based polymer, ion exchange resin, or other suitable materials.

The controller 170 may be configured to control the water supply device 120, the hydrogen-containing gas supply device 130, and the power supply 150. For example, the controller 170 may cause the water supply device 120 connected to the cathode 112 to start supplying liquid water and fill the cathode flow channel 112c with the liquid water. The controller 170 may cause the hydrogen-containing gas supply device 130 connected to the anode 114 to start supplying hydrogen-containing gas and fill the anode flow channel 114c with the hydrogen-containing gas. The controller 170 may initiate the power supply 150 to allow electric current to flow in a predetermined direction in the hydrogen purification system 100.

Next, in step S210, the water supply device 120 in the hydrogen purification system 100 is initiated to supply liquid water to the cathode 112. The water supply device 120 is connected to the cathode 112 and supplies liquid water to the cathode 112. For example, there may also be components such as the cathode flow channel 112c between the water supply device 120 and the cathode 112. The water supply device 120 and the cathode 112 are connected to each other through other components. The connection between the water supply device 120 and the cathode 112 is an indirect connection. The liquid water is continuously supplied from the water supply device 120 to the cathode 112 in an uninterrupted manner. Thereby, when the subsequent hydrogen purification reaction is performed, the hydrogen-containing gas may be continuously humidified in an uninterrupted manner to perform a continuous electrochemical hydrogen purification reaction. For example, the hydrogen purification system may not include a switch that controls the delivery of liquid water to flow into or not flow into the cathode. For instance, the water supply device 120 may start providing liquid water after connecting to the cathode 112, and supply liquid water to the cathode 112 without interruption during the hydrogen purification reaction.

In this embodiment, the liquid water may be continuously supplied from the water supply device 120 to the cathode 112 in an uninterrupted manner at a temperature of 10°C to 80°C, preferably at a temperature of 50°C to 70°C in an uninterrupted manner. For example, the liquid water may be supplied to the cathode 112 at a fixed predetermined temperature (i.e., isothermally) (e.g., supplying 50°C liquid water from the water supply device to the cathode 112), and then the hydrogen purification reaction starts. A maximum value of the hydrogen predetermined purification flux may be 100 mL/min. Under a condition of every 1 L/min hydrogen purification amount, the liquid water may be continuously supplied to the cathode 112 in an uninterrupted manner at an inlet flow rate ratio of 0.067 L/min to 0.67 L/min (i.e., 6.7 mL/min to 67 mL/min in this embodiment), preferably at a liquid water flow rate ratio of about 0.5 L/min for every 1 L/min of hydrogen purification amount, continuously supplied to the cathode 112 in an uninterrupted manner.

Subsequently, in step S220, it is confirmed that the alternating current impedance value of the purification device 110 in the hydrogen purification system 100 has satisfied a predetermined impedance condition. For example, the power supply 150 may be configured to allow electric current to flow between the anode catalyst layer 114a and the cathode catalyst layer 112a of the hydrogen purification system 100 along a predetermined direction, while the alternating current impedance analysis device 160 may be connected to the purification device 110 for measuring the alternating current impedance value of the purification device 110. For example, the alternating current impedance analysis device 160 may be configured to connect with the anode gas diffusion layer 114b and the cathode gas diffusion layer 112b to measure the alternating current impedance value of the purification device 110. When the alternating current impedance analysis device 160 is initiated, it generates an electric current flowing between the anode gas diffusion layer 114b and the cathode gas diffusion layer 112b of the hydrogen purification system 100. At this time, the impedance value of this electric current, i.e., the alternating current impedance value, may be measured by means of the alternating current impedance analysis device 160.

The alternating current impedance value of the purification device 110 may vary depending on the material of the electrolyte membrane 116. The predetermined impedance condition may be selected appropriately based on the material of the electrolyte membrane 116. In this embodiment, the predetermined impedance condition is that the alternating current impedance value of the purification device 110 is less than a purification set impedance value. The purification set impedance value may vary depending on the material of the electrolyte membrane 116. For example, when the material of the electrolyte membrane 116 is a fluorocarbon-based polymer, the purification set impedance value may be set to 0.001 ohm (Ω)/cm² to 0.002 ohm/cm². When the material of the electrolyte membrane 116 is a hydrocarbon-based polymer, the purification set impedance value may be set to 0.002 ohm/cm² to 0.005 ohm/cm². When the material of the electrolyte membrane 116 is an ion exchange resin, the purification set impedance value may be set to 0.004 ohm/cm² to 0.010 ohm/cm². The hydrogen-containing gas supply device 130 may be initiated only when the predetermined impedance condition is satisfied.

Then, in step S230, the hydrogen-containing gas supply device 130 in the hydrogen purification system 100 is initiated to supply hydrogen-containing gas to the anode 114. The hydrogen-containing gas supply device 130 is connected to the anode 114 to supply hydrogen-containing gas to the anode 114. For example, there may also be components such as an anode flow channel 114c between the hydrogen-containing gas supply device 130 and the anode 114. The hydrogen-containing gas supply device 130 and the anode 114 are connected to each other through other components. The connection between the hydrogen-containing gas supply device 130 and the anode 114 is an indirect connection. The hydrogen-containing gas may be a mixed gas. For example, the hydrogen-containing gas must include hydrogen, and may further include nitrogen, carbon dioxide, water vapor, or other gases.

Subsequently, in step S240, a hydrogen purification reaction is performed to remove non-hydrogen gases from the hydrogen-containing gas and increase the concentration of hydrogen. During performance of the hydrogen purification reaction, hydrogen may be generated at the cathode 112. The purified hydrogen may flow out of the cathode outlet 113b of the cathode separator 113 together with the liquid water performed after the hydrogen purification reaction (referred to as "treated liquid water").

The purified hydrogen and the treated liquid water may further pass through a gas-liquid separation device 140. The gas-liquid separation device 140 may be used to separate the treated liquid water and the purified hydrogen flowing out from the cathode outlet 113b of the cathode separator 113. The purified hydrogen discharged from the gas-liquid separation device 140 may be discharged to a purified hydrogen discharge pathway 180 and collected.

In this embodiment, the treated liquid water flowing out from the cathode outlet 113b of the cathode separator 113 may pass through the gas-liquid separation device 140, then flow through the water supply device 120 to re-enter the cathode inlet 113a of the cathode separator 113. Thereby, the treated liquid water re-entering the cathode 112 from the cathode inlet 113a of the cathode separator 113 may be repeatedly and cyclically used. However, the disclosure is not limited thereto. In other embodiments, the treated liquid water flowing out from the cathode outlet 113b of the cathode separator 113 may be directly discharged from the hydrogen purification system 100 without passing through the gas-liquid separation device 140, or may be discharged from the hydrogen purification system 100 after passing through the gas-liquid separation device 140. The treated liquid water flowing out from the cathode outlet 113b of the cathode separator 113 may be discharged from the hydrogen purification system 100 without cyclically used.

### E xample 1

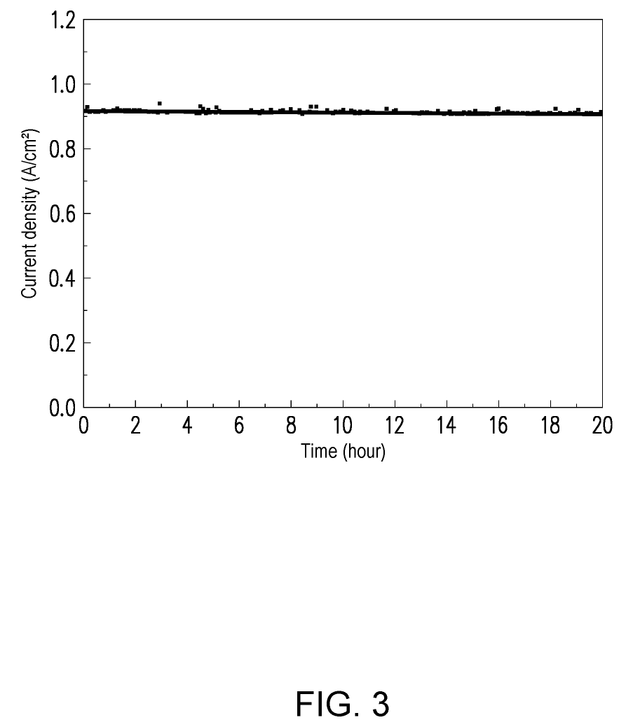

The purification device of the hydrogen purification system used in Example 1 has an active area of 12.25 cm², and the operating temperature of the purification device is set to 50°C. A hydrogen-containing gas (a mixed gas of hydrogen and nitrogen, wherein the inlet flow rate of hydrogen is 100 mL/min and the inlet flow rate of nitrogen is 100 mL/min) at room temperature is introduced into the anode, and liquid water at room temperature is introduced into the cathode (based on the condition of every 1 L/min hydrogen purification amount, the inlet flow rate of water may be set from 0.067 L/min to 0.67 L/min, with the inlet flow rate in this example set to 10 mL/min). Under the condition of applying a voltage of 0.08 V, a continuous hydrogen purification reaction is performed for 20 hours. The results show that the current remains stable during the purification, with no observed current decay (as shown in FIG. 3).

### Comparative Example 1

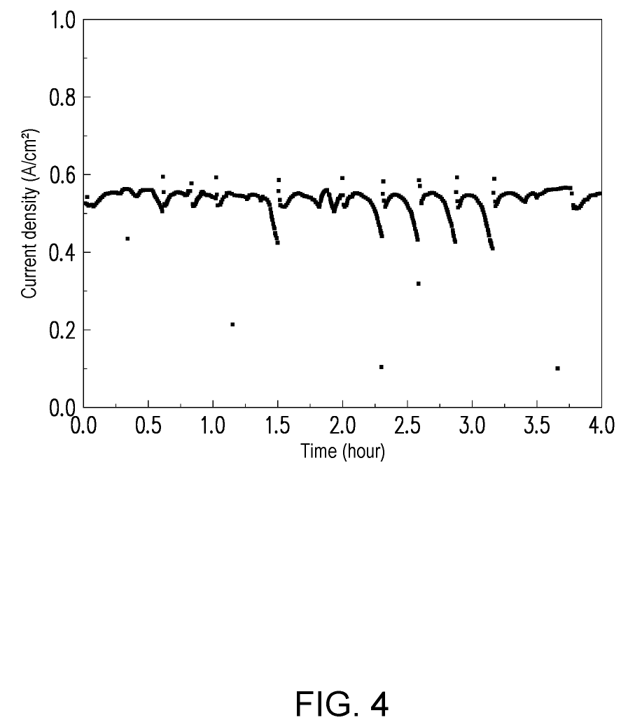

The purification device of the hydrogen purification system used in Comparative Example 1 has an active area of 12.25 cm², and the operating temperature of the purification device is set to 50°C. A hydrogen-containing gas (a mixed gas of hydrogen and nitrogen, wherein the inlet flow rate of hydrogen is 100 mL/min and the inlet flow rate of nitrogen is 100 mL/min) at room temperature is introduced into the anode, and water vapor with a relative humidity of 100% is introduced through the anode inlet to humidify the interface of the hydrogen purification reaction. Under the condition of applying a voltage of 0.08 V, a continuous hydrogen purification reaction is performed for 4 hours. The results show that during the purification, as protons are transported to the cathode in the form of hydrated ions and reduced back to hydrogen in the purification reaction process, water is discharged from the cathode, which leads to the humidified gas with 100% relative humidity still being unable to maintain the required wetness of the reaction interface, thereby causing insufficient humidity and resulting in an unstable purification reaction (as shown in FIG. 4).

### Comparative Example 2

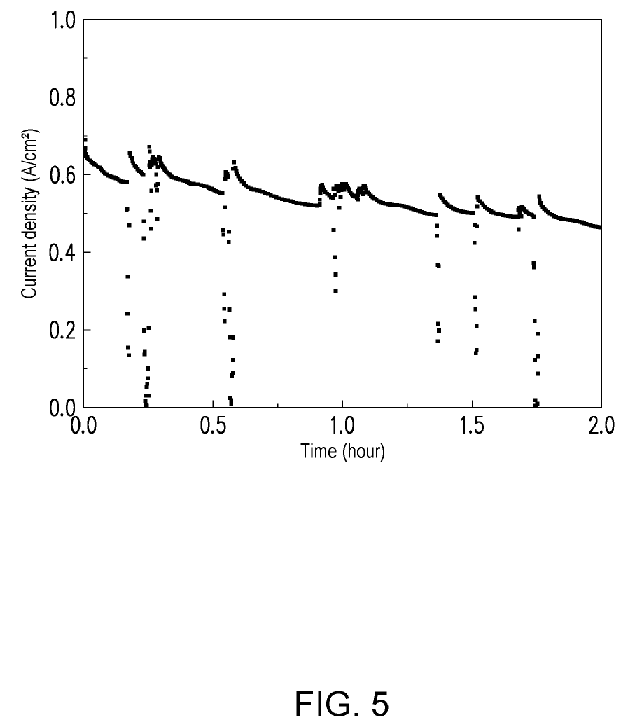

The purification device of the hydrogen purification system used in Comparative Example 2 has an active area of 12.25 cm², and the operating temperature of the purification device is set to 50°C. A hydrogen-containing gas (a mixed gas of hydrogen and nitrogen, wherein the inlet flow rate of hydrogen is 100 mL/min and the inlet flow rate of nitrogen is 100 mL/min) at room temperature is introduced into the anode, and water vapor with a relative humidity greater than 100% is introduced through the anode inlet to humidify the interface of the hydrogen purification reaction. Under the condition of applying a voltage of 0.08 V, a continuous hydrogen purification reaction is performed for 2 hours. The results show that the initial value of the purification current is higher than that of Comparative Example 1, indicating that the humidified gas with a relative humidity greater than 100% may better maintain the required wetness of the reaction interface. However, due to the highly humidified environment, liquid water may form, which leads to an instantaneous increase in impedance during water discharge, causing fluctuations in the instantaneous current (as shown in FIG. 5). Furthermore, the results show that operating in a highly humidified environment for an extended period may cause problems such as local flooding, resulting in a decrease in purification current. The aforementioned factors may also lead to accelerated material degradation, which is unfavorable for practical applications.

Based on the above, the exemplary embodiments provide a hydrogen purification system including a water supply device connected to the cathode and continuously supplying liquid water to the cathode in an uninterrupted manner. Thus, the hydrogen purification system and the hydrogen purification method using the same may perform a continuous hydrogen purification reaction during the performance of the hydrogen purification reaction, and the reaction process may have good stability, thus having good applicability.

Although the disclosure has been disclosed in the above embodiments, it is not intended to limit the disclosure. Any person skilled in the art may make some changes and modifications without departing from the spirit and scope of the disclosure. Thus, the protection scope of the disclosure shall be subject to that defined by the appended claims.

What is claimed is:

1. A hydrogen purification system, comprising:
a purification device, comprising an anode, a cathode, and an electrolyte membrane located between the anode and the cathode;
a water supply device, connected to the cathode and providing liquid water to the cathode; and
a hydrogen-containing gas supply device, connected to the anode to supply hydrogen-containing gas to the anode,
wherein during a hydrogen purification process, the liquid water is continuously supplied to the cathode in an uninterrupted manner.

2. The hydrogen purification system according to claim 1, wherein the liquid water is continuously supplied to the cathode in an uninterrupted manner at a temperature of 10°C to 80°C.

3. The hydrogen purification system according to claim 1, wherein under a condition of every 1 L/min hydrogen purification amount, the liquid water is continuously supplied to the cathode in an uninterrupted manner at a flow rate of 0.067 L/min to 0.67 L/min.

4. The hydrogen purification system according to claim 1, wherein the cathode comprises a cathode catalyst layer and a cathode gas diffusion layer, the cathode catalyst layer is in contact with the electrolyte membrane, and the cathode gas diffusion layer is in contact with a cathode separator,
the cathode separator and the cathode have a cathode flow channel therebetween,
the liquid water flows in through a cathode inlet of the cathode separator, and after passing through the cathode flow channel, liquid water and purified hydrogen flow out through a cathode outlet of the cathode separator.

5. The hydrogen purification system according to claim 4, further comprising a gas-liquid separation device to separate the liquid water and the purified hydrogen flowing out from the cathode outlet of the cathode separator.

6. The hydrogen purification system according to claim 4, further comprising a gas-liquid separation device, wherein after the liquid water flowing out from the cathode outlet of the cathode separator passes through the gas-liquid separation device, it flows through the water supply device to re-enter the cathode inlet of the cathode separator.

7. The hydrogen purification system according to claim 1, wherein the anode comprises an anode catalyst layer and an anode gas diffusion layer, the anode catalyst layer is in contact with the electrolyte membrane, and the anode gas diffusion layer is in contact with an anode separator,
the anode separator and the anode have an anode flow channel therebetween,
the hydrogen-containing gas is introduced through an anode inlet of the anode separator, and after passing through the anode flow channel, hydrogen-containing gas that has not passed through the cathode flows out through an anode outlet of the anode separator.

8. The hydrogen purification system according to claim 1, further comprising an alternating current impedance analysis device connected to the purification device to measure an alternating current impedance value of the purification device.

9. A hydrogen purification method, comprising:
using the hydrogen purification system according to claim 1;
initiating the water supply device to supply the liquid water to the cathode;
introducing the hydrogen-containing gas; and
performing a hydrogen purification reaction,
wherein during a hydrogen purification process, the liquid water is continuously supplied to the cathode in an uninterrupted manner.

10. The hydrogen purification method according to claim 9, wherein after starting to supply the liquid water, it is first confirmed that an alternating current impedance value of the purification device has satisfied a predetermined impedance condition, and then the hydrogen-containing gas is introduced.

11. The hydrogen purification method according to claim 10, wherein the predetermined impedance condition is that an alternating current impedance value of the purification device is less than a purification set impedance value.
